(19) United States
(12) Patent Application Publication
(10) Pub. No.: US 2016/0094047 A1
(43) Pub. Date: Mar. 31, 2016

(54) HEATABLE CAPACITOR AND CIRCUIT ARRANGEMENT

(71) Applicant: SIEMENS AKTIENGESELLSCHAFT, Munchen (DE)

(72) Inventors: MICHAEL FINKENZELLER, MUNCHEN (DE); PETER MAISEL, NURNBERG (DE); MARTIN SALITERNIG, HERZOGENAURACH (DE)

(73) Assignee: SIEMENS AKTIENGESELLSCHAFT, Munchen (DE)

(21) Appl. No.: 14/865,932

(22) Filed: Sep. 25, 2015

(30) Foreign Application Priority Data
Sep. 26, 2014 (DE) 102014219612.4

(51) Int. Cl. H02J 5/00; H01G 7/04

(52) U.S. Cl. CPC H02J 5/005; H01G 7/04

(57) ABSTRACT

A capacitor module having a capacitor and a heater is disclosed. The temperature of the capacitor can be measured by means of a temperature sensor and the temperature of the capacitor is influenced by the heater. The capacitance value changes as a function of the temperature. Thus a circuit apparatus having a resonance converter can be tuned thereby, since the capacitance value can be regulated or controlled.

### CROSS-REFERENCES TO RELATED APPLICATIONS

This application claims the priority of German Patent Application, Serial No. 10 2014 219 612.4, filed Sep. 26, 2014, pursuant to 35 U.S.C. 119(a)-(d), the content of which is incorporated herein by reference in its entirety as if fully set forth herein.

### BACKGROUND OF THE INVENTION

The invention relates to a heatable capacitor and a circuit arrangement having said heatable capacitor. More particularly, in particular, the circuit arrangement relates to a resonance converter for the wireless charging of an electric vehicle and to a method for operating a resonance converter, a load resonance converter, in particular.

A resonance converter is a DC converter that uses a resonant circuit and converts a DC voltage into a single-phase or multi-phase AC voltage, in particular. Resonant DC converters use an electric resonance circuit or resonant circuit having electrical reactances, capacitance and inductance, for energy transmission purposes. For optimal power transmission, the DC converter is operated at or in the range of the resonance frequency.

The characteristics of the resonant circuit may vary very significantly on account of component tolerances and environmental influences such as the ambient temperature, for example. This results in a detuning of the resonant circuit, which can be balanced by changing the operating frequency, for example.

With a wireless transmission of energy in an electromagnetic transmission system having a primary coil and a secondary coil, the tuning or detuning of the system also results from the varying position of the primary coil and secondary side of the charging system. This results in a compensation network being provided in a resonance converter used for inductive charging, using firmly connected capacitors for example. The use of different compensation methods allows the transmission system to be tuned. In particular, the primary and secondary side leakage inductance of the respective coil system is compensated in the transmission system. An adjustment to the respective electric operating point of the energy transmission system is realized by changing the operating frequency or by an adjustable voltage on the primary-side converter, for example. In order not to interfere with the keyless access systems in the vehicle, the permissible bandwidth of the variable operating frequency of the converter only however amounts to approx. 10 kHz in the automobile field, for instance. Here the voltage range to be adjusted on the primary side converter is in most cases also below 10% of the nominal voltage. The control range for the adjustment of the energy transmission system to produce as efficient a transmission as possible from the system, is therefore very significantly restricted. Thus, a further operating range of the energy transmission system is not desired in most cases. Instead, the majority of the transmission systems are optimized such that a certain system tolerance is permissible for a specific operating point. This results in a fixed tuning between the coil system and a fixed compensation network.

Since, in inductive charging systems, a geometric offset of the transmitter coil on the primary side) and the receiver coil on the secondary side is possible, the controller of the resonance circuit can no longer balance out the detuning if the resonance circuit has certain specifications, because normative requirements restrict the control range of the operating frequency, also referred to as the “working” frequency. The primary side is tuned relative to the secondary side so that an efficient energy transmission is possible.

The use of a capacitor module having a variable reactance, particularly a variable capacitance, allows a resonance converter, for instance one that is provided for use in a wireless battery charging system for electric vehicles, in particular, have a configuration that is particularly robust with respect to possible interference during the charging process. A change in duty cycle, mechanical apparatus for adjusting capacitance, a variable capacitor for example, or a stepped connectable and closable capacitor bank can be used to tune a resonance converter. However, a mechanically adjustable capacitor cannot be easily replaced in the power electronics by a gyrator or suchlike. In practice, a mechanically or electromechanically adjustable capacitors do not always provide a satisfactory solution, on account of their susceptibility to need repair as well as their high cost.

### SUMMARY OF THE INVENTION

The invention provides a reactance, a circuit arrangement that advantageously allows in particular for a simple influencing of a resonant circuit, and a corresponding method. The advantages explained below in connection with the capacitor module and the circuit arrangement also analogously apply to the method, and vice versa.

In accordance with the invention, a variable compensation network is provided on the primary and/or secondary side of the wireless energy transmission system with the aid of a temperature-dependent electrical capacitance and components for temperature change. The resulting actuator allows for an additional degree of freedom for instance when tuning the wireless energy transmission system. The actuator is a capacitor module, the capacitance value of which changes as a function of the temperature and which has a heater for changing the temperature. The compensation network or resonance converter is variably configured by changing that capacitance. This allows for a particularly broad operating range.

A capacitor module has one capacitor or a plurality of capacitors connected in series or in parallel, and an electrical resistor or a Peltier element as a heater. In addition to the heater, the capacitor module can also have a cooling system. A Peltier element can be used both as a heater and also as a cooling system. A required temperature can be adjusted such that an optimum adjustment of the temperature-dependent capacitance is produced on the respective electrical operating point of the resonance converter in a thermally sealed housing, with the aid of an electrical heater and/or cooling facility. The capacitor module advantageously forms a module for the capacitor with a heater or cooling system.

For instance, the capacitor module has a housing in which the at least one capacitor and the heater or the cooling system are positioned. This capacitor module can be cast for instance, or positioned on a printed circuit board for instance. In one embodiment the capacitor module is electrically insulated, apart from its electrical connections. Integration into an overall module can be advantageous, but also construction using individual components, e.g. on a circuit carrier, although steps should then be taken to ensure that the heater influences the temperature of the capacitor. The capacitor module can also have one or multiple sensors.

In one embodiment of the capacitor module, aside from the capacitor and the heater, and/or a cooling system, the module also has a temperature sensor. The temperature measured by this sensor depends on the temperature of the respective capacitor. The temperature of the capacitor or at least at the capacitor can be measured by means of the temperature sensor so that knowledge of this temperature means that the capacitance of the one or the plurality of capacitors of the capacitor module can be inferred.

In order to be able to use the heater or the cooling system as an element to modify the electrical property of the capacitor and thus of the capacitor module, the material selected for the capacitor changes its property as a function of its temperature. Electrolytic capacitors and also ceramic capacitors are known for instance. Properties of specific materials used to produce a ceramic capacitor are advantageously put to use in these capacitors.

In one advantageous embodiment the capacitor is a ceramic capacitor, in particular one made of a class-2-ceramic. Ferro-electrical materials are significantly field-strength-dependent and the capacitance values of class-2-ceramics have a large temperature and voltage dependency. Known class-2-ceramics are: X7R, Z5U, Y5V, X7S or X8R, for example. Ceramic capacitors of type Y5V in class-2-produce a change in the capacitance of approx. 80% in the temperature range of 25[Equation]C. to 90[Equation]C., for example. For example for a 10 nF capacitor this would mean that a range of 2 nF to 10 nF can be covered by the capacitor. Capacitors of the type Z5U also exhibit a strong dependency on temperature, and capacitors of the type X7R can be used, but only show approx. a 10% change in this range.

In one embodiment of the capacitor module the capacitor is galvanically separated from the heater and/or the cooling system and/or the temperature sensor by a circuit board. This separates the capacitor from other elements, like the heater for example. This is advantageous when the capacitor is then operated with a higher voltage, or at a potential that is different from that of the other elements, like the heater and temperature sensor.

The heater or the cooling system can be integrated into a circuit arrangement in which the capacitance is changed by a heater having a control facility, such as a programmable logic controller, a power converter with microelectronics or another facility or a microcrontroller, for example. Advantageously, the control facility is used as a temperature regulator or controller that influences the heater, or can switch it on or off, for instance. In particular, the circuit arrangement relates to a wireless battery charging system that can be deployed to charge an electric vehicle, for instance.

Capacitor modules or circuit arrangements in accordance with the invention can be used by resonance converters to charge accumulators, particularly batteries, which is naturally applicable to the charging of an electric vehicle. To this end, a circuit arrangement comprising a primary-side winding having an energy-feeding resonance converter and an activation circuit for its activation can advantageously be provided. The secondary side is generally not mechanically connected to a primary-side winding.

Parameters that are relevant to the charging process may change during the wireless charging of an accumulator: a rapid change in the position of the accumulator to be charged relative to the charging station for instance or in the event material is introduced into a gap between the charging station and an object in which the accumulator to be charged is disposed. Ideal operation of a charging station, in which the accumulator to be charged and a secondary-side winding arranged in the same object are geometrically precisely disposed relative to the primary-side, in other words charging station-side winding, can thus only be ensured in practice, particularly when charging electric vehicles, with special safety provisions.

In accordance with the invention, when operating a resonance converter which feeds energy into the primary-side winding of a transformer or an inductive charging system, particularly a charging station for the wireless charging of an electrically powered vehicle, the capacitance in the resonant circuit can now be changed. For instance, this permits operation of the resonance converter in an overresonant range. A controller activates the resonance converter.

Since the capacitance needed can be adjusted or regulated by a temperature regulator in the capacitor module, the result is an optimally-adjusted transmission system that provides high-efficiency energy transmission. The permissible frequency range of the operating frequency of the primary-side converter can then be set lower, which has a positive effect on electromagnetic compatibility and the scale of the filter and shielding measures needed can then be much reduced because of that lower operating frequency range. This provides a further advantageous embodiment of the circuit arrangement and the capacitor module.

In a method in accordance with the invention, a temperature that relates to the temperature of the capacitor and, in particular, the capacitor temperature, is measured during operation of the circuit arrangement or capacitor. The heater of a capacitor module is activated or deactivated in response to the temperature value measured for the capacitor. If the heater is a resistor, then its heat output is dependent on the current and the voltage supplied. Advantageously, current and/or voltage supplied can be changed, in steps or linearly. The capacitor can consequently be heated as a function of a measured capacitor temperature.

In a particular embodiment of the method, the capacitor temperature values are stored and used to calculate a residual service life of the capacitor. Since the service life of the capacitor can be reduced by high temperatures, and a residual service life can be calculated on the basis of the stored capacitor temperature values that is a function of an overall service life assigned to the component.

In a particular advantageous embodiment of the method, information relating to the replacement of the capacitor is generated as a function of the calculated residual service life. This information is conveyed to a service technician or to service software, for instance. Prompt replacement of a capacitor or a capacitor module prior to its failure can increase the availability of the resonance system in which the capacitor module is deployed.

### BRIEF DESCRIPTION OF THE FIGURES

The invention will be better understood when the detailed description of presently preferred embodiments provided below is considered in conjunction with the figures provided, in which:

FIG. 1 shows a first resonant DC converter circuit;

FIG. 2 shows a an LLC converter in a second resonant DC converter circuit;

FIG. 3 shows a secondary-side adjustable capacitor module in a resonant DC converter;

FIG. 4 shows a primary-side adjustable capacitor in a resonant DC converter;

FIG. 5 shows a primary-side parallel-connected capacitor module in a resonant DC converter;

FIG. 6 is a diagram of the temperature dependency of a capacitance;

FIG. 7 shows a heating resistor in a capacitor module;

FIG. 8 shows a Peltier element in a capacitor module;

FIG. 9 shows a capacitor bank;

FIG. 10 shows an activation facility for the capacitor module;

FIG. 11 shows a mechanical design of the capacitor module;

FIG. 12 shows a source and load of a wireless energy transmission system; and

FIG. 13 shows a thermally-insulated capacitor module.

Parts or parameters corresponding to one another are labeled with the same reference numerals in the figures.

### DETAILED DESCRIPTION OF PREFERRED EMBODIMENTS

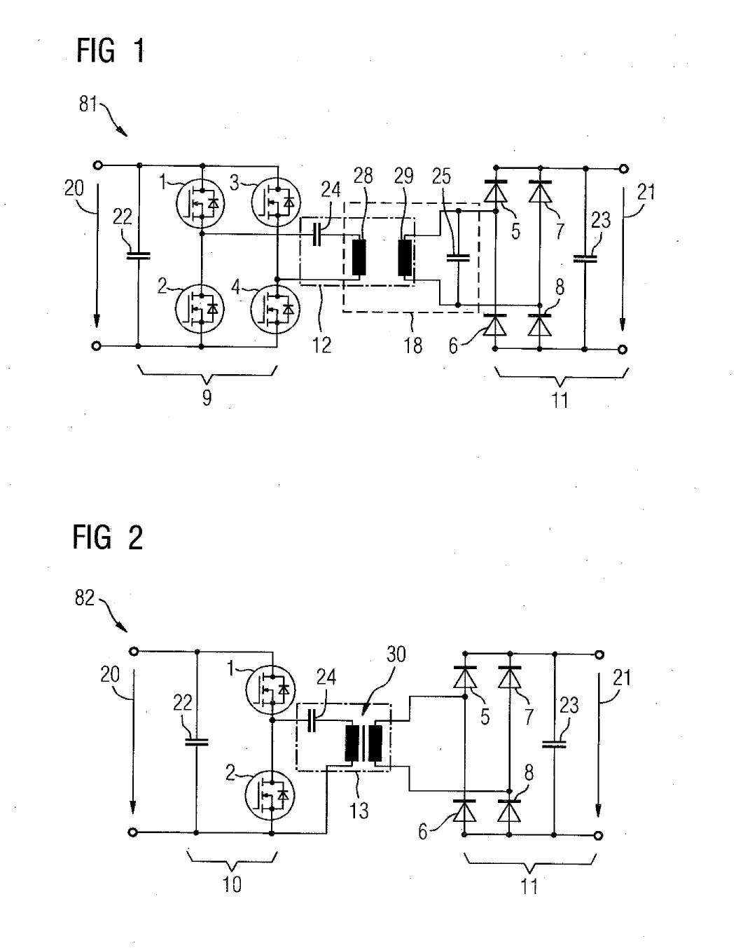

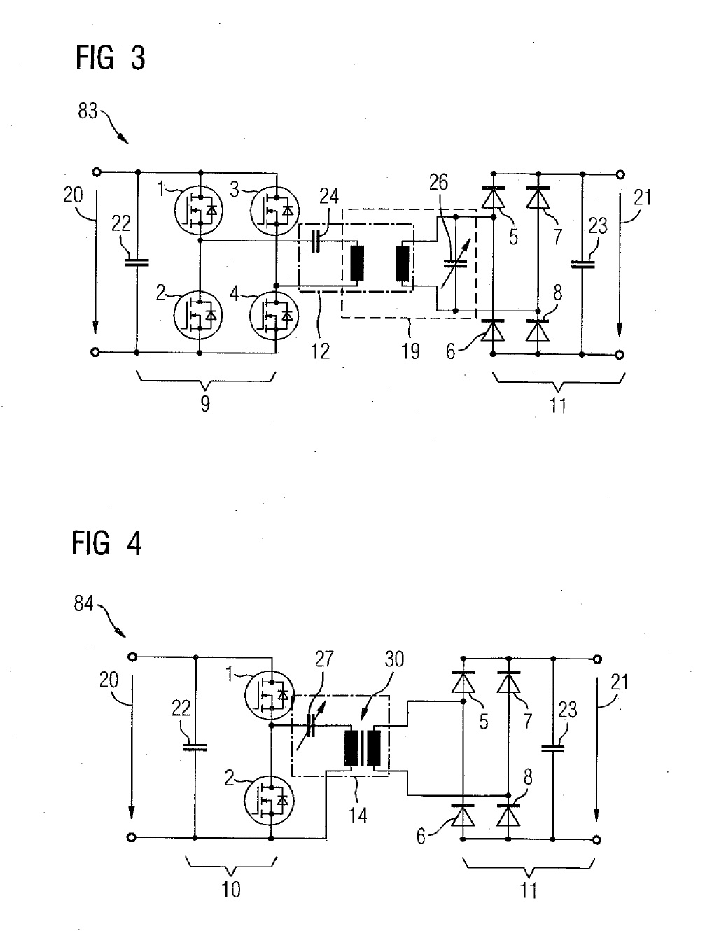

In FIG. 1, the circuit arrangement 81 is a coupled system having series or parallel circuits and couplings that provide a resonant DC converter for an inductive charging system, in particular for charging a vehicle battery, for example, having an inverter 9 and a rectifier 11. The inverter 9 has switchable power semiconductors 1, 2, 3 and 4 in a bridge circuit, and an input-side capacitance 22 across the voltage input 20. A capacitance 24 and inductance 28 are connected in series across the inverter 9 in a series circuit, thus forming a series resonant circuit 12, that is also part of the resonant circuit 18 on account of the inductive coupling of the inductance 28 with a further inductance 29 that is part of a parallel resonant circuit 18 in which that inductance 29 is parallel to a capacitance 25. The inductance 28 is also part of the resonant circuit 18, on account of the inductive coupling of the inductances 28 and 29. The parallel resonant circuit 18 is electrically connected to a rectifier 11 that is a bridge circuit having four power semiconductors 5, 6, 7 and 8, which are diodes in the example shown here. The output voltage 21 of the rectifier 11 is provided in parallel with a capacitance 23 connected in parallel across the output of the rectifier. If at least one of the resonant circuits has a capacitor module with a capacitor and heater, the oscillatory characteristics of the circuit can be changed by changing the capacitance value of the capacitor by heating the capacitor. FIG. 3 shows such a module.

In FIG. 2, the circuit arrangement 82 is an LLC converter, in which the primary side has an inverter 10 with two switchable power semiconductors 1, 2, connected parallel to a capacitance 22 across the input voltage 20, and a rectifier 11 on the secondary side. The primary side and secondary side are coupled by a transmitter 30. The primary side forms a resonant circuit 13 with the capacitance 24. This series resonant circuit 13 is connected on one end to a potential of the input voltage 20, but on the other end to a tap between the two power semiconductors 1 and 2 that are connected in series. Thus the series resonant circuit 13 is connected in parallel with one of the switchable power semiconductors 1 or 2. Thus, in principle, the parallel resonant circuit can serve as a series resonant circuit, and vice versa. If a capacitor module with a capacitor and heater is now added to the resonant circuit 13, its oscillatory characteristics can be changed by heating the capacitance , which changes the capacitance value of the capacitance. FIG. 4 shows such a circuit.

A heatable and/or coolable capacitor module can be applied to or used in each resonant topology and/or system, in which the power transmission is based on a principle similar to that described above, that is, the principle of resonance.

In FIG. 1 capacitor 25 on the secondary side provides a parallel compensation of the main resonant circuit 12 on the primary side. This capacitor can be replaced by an adjustable one, as shown the circuit arrangement 83 in FIG. 3. In FIG. 3, an adjustable capacitor 26 has replaced capacitor 25. This adjustable capacitor is a capacitor module having both a capacitor and means for changing the temperature, a heater for example. The arrow indicates that the capacitor is adjustable;

The system shown in FIG. 2 can be modified in a similar way by providing an adjustable capacitor 27 as a replacement for the capacitor 24, as shown in the circuit arrangement 84 of FIG. 4, which interrupts a main LC circuit 14 of that resonant converter 84. A capacitor 24 (see FIG. 2) is also replaced here by an adjustable variant 27, which is another capacitor module that includes a heater. The heater, for instance, can be a Peltier element or a comparably cost-effective resistor.

The further circuit arrangement 85 shown in FIG. 4 is similar to that in FIG. 5, except that the primary-side resonant circuit has multiple of capacitive components 24 and 27 deployed in parallel with each other in the series resonant circuit on the side assigned to the inverter 10. The capacitances can also be composed of a plurality of connected capacitances connected in series and/or in parallel circuits. The example in FIG. 5 shows a non-adjustable capacitance 24 and an adjustable capacitance 27 connected in parallel with each other. A calculable overall capacitance is produced on account of this parallel circuit. Both the adjustable capacitance 27 and also the parallel circuit of both capacitances 24 and 27 can be referred to as a capacitor module, since the overall capacitance can be changed by means of temperature change by a capacitor with a heater. The capacitor module 80 forms the resonant circuit 15 together with the transmitter 30.

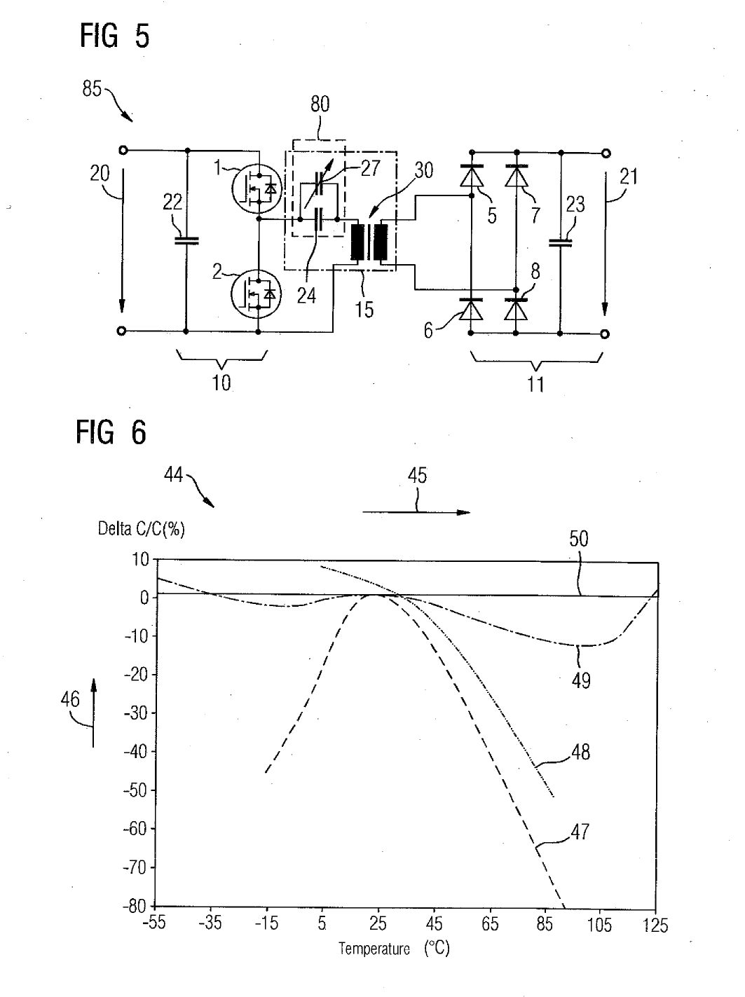

The diagram 44 in FIG. 6 has temperature in degrees Celsius on a first axis 45 and a capacitance change Delta C/C (%) on a second axis 46. A first curve 47 shows the change in the capacitance as a function of the temperature in a capacitor with Y5V material. A second curve 48 shows the change in the capacitance as a function of the temperature in a capacitor with Z5V material. A third curve 49 shows the change in the capacitance as a function of the temperature in a capacitor with X7R material. The fourth curve 50 is a zero line, which is temperature-independent. The capacitance value can thus be changed in an actively regulated or controlled manner if a capacitor module has a material that is temperature-dependent and actively changes the temperature using a heater or cooling system.

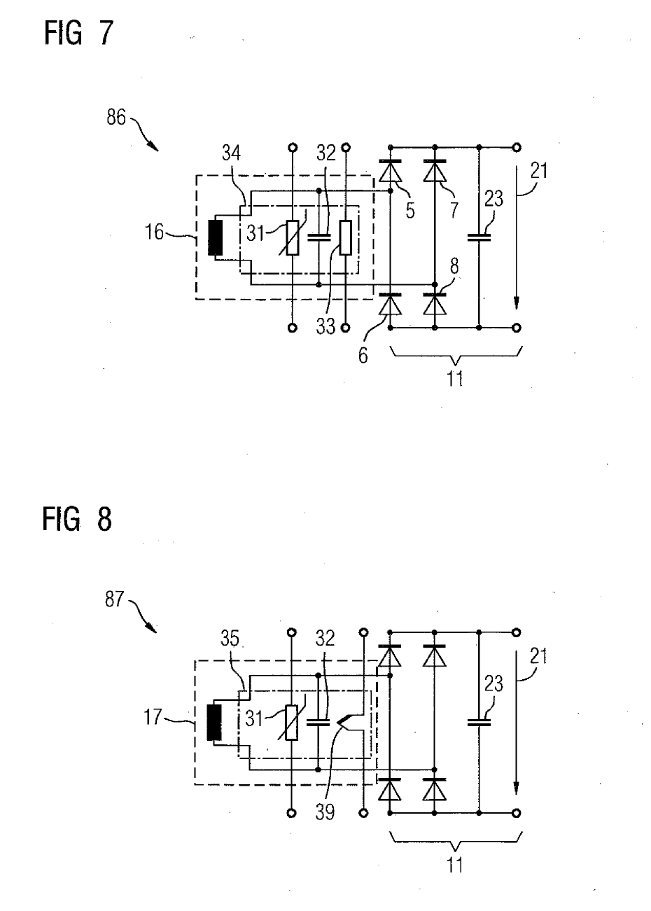

A parallel resonant circuit 16 is shown in the circuit arrangement 86 in FIG. 7, wherein an inductance 29 and a capacitor module 34 are connected in parallel. Examples of adjustable capacitor modules 26 or 27 are known from FIGS. 3 to 5. In FIG. 7, the capacitor module 34 is shown in greater detail and includes a capacitor 32 having a specific capacitance, a resistor 33 that heats the capacitance 32, and a temperature sensor 31. In FIG. 7, only the secondary side of an inductive charging system or DCDC converter is shown for the sake of simplification. The capacitor 32 has a YSV material. for instance, and the temperature sensor 31 is optional, since the heating resistor 33 can also be operated using a temperature model.

If a capacitor module 35 is to be coolable as well as heatable, this can be configured as shown in FIG. 8. In this arrangement 87 the heating resistor is replaced here by a Peltier element 39, for both heating and cooling.

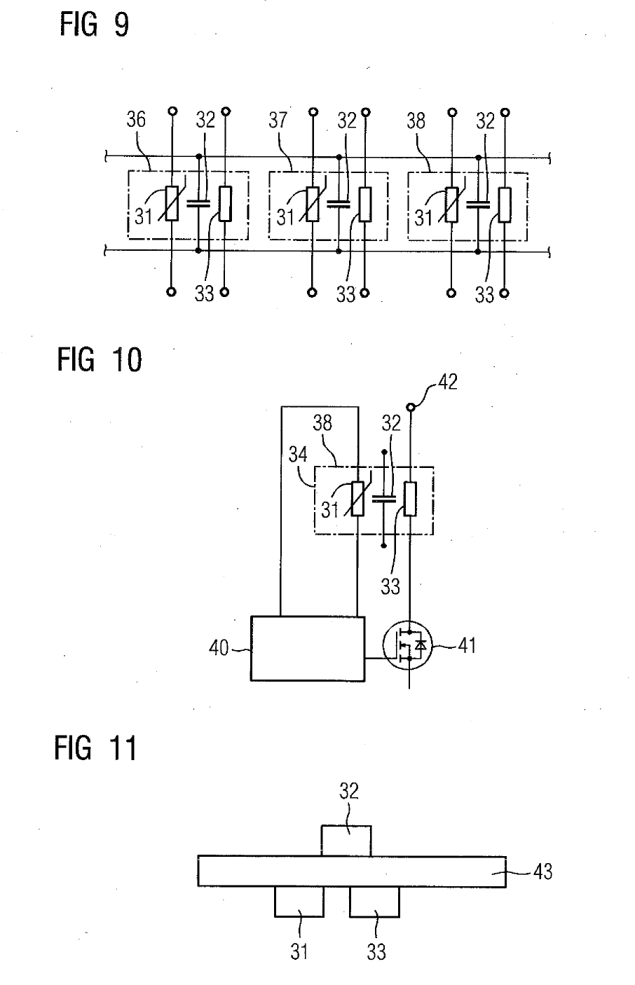

To cover a greater range of capacitance values, a circuit comprising a plurality parallel of capacitor modules 36, 37 and 38 can be used, as shown in FIG. 9. This enables a larger range of the possible operating voltage to be covered. A series circuit of the capacitor modules is naturally also possible, which is however not shown.

A microcontroller 40 is shown in FIG. 10 as a possible means for regulation or control of the capacitance value of the capacitor module 34, using the temperature sensor 31. This microcontroller 40 in turn controls the power supplied to the heater, using a circuit breaker 41 and the pulse width method to power the heating resistor 33, for example. A further method of regulating or controlling the capacitance value of the capacitor module controls the current being received by the heating resistor in the control loop of the DCDC converter or the inductive charging system. Thus, a detected change in the LC circuit resonance can be actively counteracted by heating or cooling the capacitor module.

To achieve the best possible thermal coupling of the necessary components within the capacitor module, in particular the capacitor and heater, a special module having a compact design may be desirable, such as the printed circuit board shown in FIG. 11, for example. The capacitor 32 is disposed on a first side (e.g. an upper side) of the printed circuit board 43, which can also be an electric insulator. The heating resistor 33 and the temperature sensor 31 are disposed on a second side (e.g. an underside) of the printed circuit board 43. A close spatial connection between these components is provided thereby on the one hand, but a defined electrical insulation between them is also possible because of the printed circuit board 43.

The use of a capacitor module, of the described type in a resonant circuit, that is an adjustable capacitor, has a wide variety of advantages. For instance, no movable parts are required. Galvanic separation between an activation/measurement arrangement and the capacitor is possible, so that high voltages (>100 V) can be separated from low voltages ([Equation] 48 V). Either a pulse-width signal or regulated DC voltage/current are possible options, so a wide variety of heaters can be used. Both parallel as well as a series connection of the capacitor module is possible in the resonant circuits.

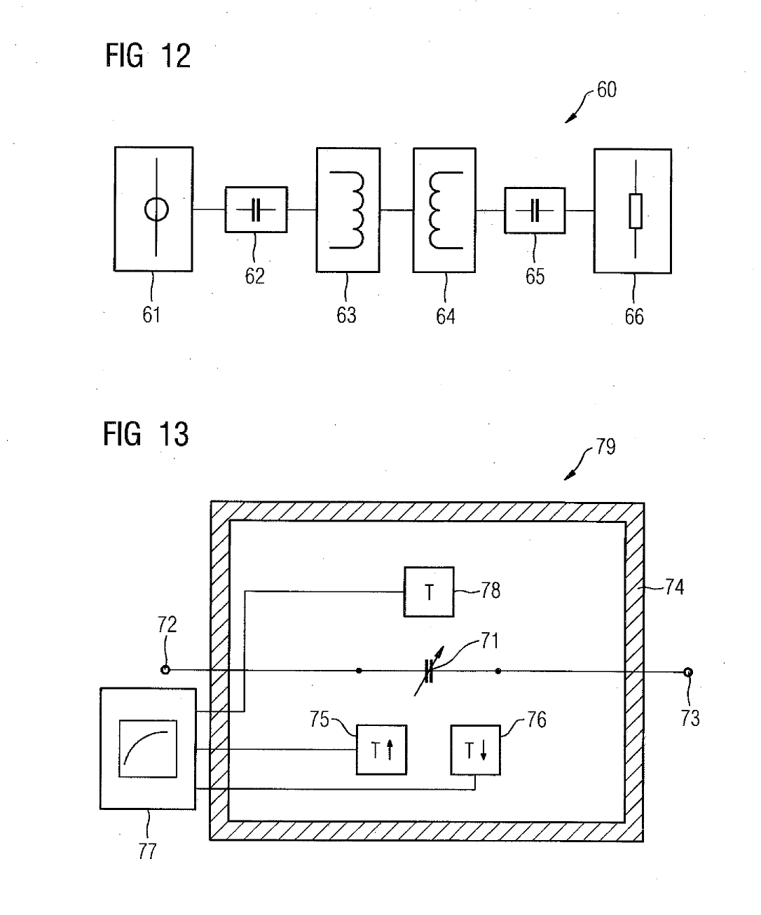

FIG. 12 shows a wireless energy transmission system 60 wherein an electrical source 61, feeds a primary-side coil system 63 through a primary-side capacitive compensation 62 circuit. The primary-side coil system 63 is inductively coupled to a secondary-side coil system 64 that feeds an electric load 66. The secondary side of the wireless energy transmission system has secondary-side capacitive compensation 65.

The primary-side compensation and also the secondary-side compensation can be dynamized by a capacitor, the capacitance value of which can be adjusted. For dynamization purposes, a capacitor module 79 can be used, as shown in FIG. 13, for example. FIG. 13 shows capacitor module 79 having a temperature-dependent capacitor 71, a temperature sensor 78, and both a heater 75 and a cooling system 76 surrounded by thermal insulation 74. The heater 74, cooling system 76 and also the sensor 78 are connected to a temperature regulator 77 disposed outside of the insulation 74.

The invention has been disclosed with particular reference to presently preferred embodiments. However, it will be apparent to one skilled in the art that variations and modifications are possible without departing from the spirit and scope of the invention,

What is claimed is:

1. A capacitor module comprising: a heater, and a variable capacitor having a variable capacitance that varies as a function of its temperature, said heater being adapted to modify the temperature of the variable capacitor.

2. The capacitor module of claim 1, further comprising a temperature sensor adapted to control the heater, said temperature sensor being connected to the heater to stabilize the temperature of the capacitor.

3. The capacitor module of claim 1, wherein the capacitor is a ceramic capacitor.

4. The capacitor module of claim 3, having a class 2 ceramic capacitor.

5. The capacitor module of claim 1 further comprising an insulator galvanically separating the heater from the temperature sensor.

6. The capacitor module of claim 5, wherein the galvanic separation is provided by a printed circuit board.

7. A wireless energy transfer arrangement, the wireless arrangement comprising a thermal change device, and a variable capacitor having a variable capacitance that varies as a function of its temperature, said thermal change device being adapted to modify the temperature of the variable capacitor.

8. The wireless energy transfer arrangement of claim 7, further comprising a microcontroller adapted to control the thermal change device, said microcontroller being connected to the thermal change device to stabilize the temperature of the capacitor.

9. The wireless energy transfer arrangement of claim 7, further comprising a resonance circuit, said capacitor being connected in said resonance circuit.

10. The wireless energy transfer arrangement of claim 9, further comprising:
a temperature sensor adapted to control the temperature of the capacitor in the resonance circuit so that the resonance circuit is tuned to provide efficient wireless energy transfer by the wireless energy transfer arrangement.

11. A method for operating a circuit arrangement having a temperature-variable capacitor and a thermal change device, comprising:
determining a temperature affecting the output of the circuit arrangement;
modifying the temperature of the temperature-variable capacitor to change the output of the circuit arrangement using the thermal change device.

12. A method for operating a circuit arrangement having a temperature-variable capacitor and a thermal change device, comprising:
determining a temperature of a temperature-variable capacitor having a capacitance that varies as a function of its temperature;
modifying the temperature of a temperature-variable capacitor using the thermal change device until a predetermined output from the circuit arrangement is obtained.

13. The method of claim 12, further comprising stabilizing the output of the circuit arrangement by modifying the temperature of the temperature-variable capacitor as a function of the determined temperature of the temperature-variable capacitor.

14. The method of claim 12 wherein the circuit arrangement is a wireless energy transfer arrangement and the temperature-variable capacitor is in a resonance circuit, the method further comprising modifying the temperature of the temperature-variable capacitor so that the resonance circuit is tuned to provide efficient wireless energy transfer by the wireless energy transfer arrangement.

15. The method of claim 12 further comprising:
storing determined temperatures of the capacitor; and
calculating the residual service life using stored values.

16. The method of claim 14 further comprising:
conveying capacitor replacement information to a technician as a function of residual service life.
